(19) United States
(12) Patent Application Publication
(10) Pub. No.: US 2006/0032109 A1
(43) Pub. Date: Feb. 16, 2006

(54) Modular fishing lure

(76) Inventor: John Anthony Chiodo, Metamora, MI (US)

Correspondence Address: MITCHELL M. MUSIAL II, PLLC, 6960 ABBOTT TERRACE, WEST BLOOMFIELD, MI, 48323, US

(21) Appl. No.: 10/917,946

(22) Filed: Aug. 13, 2004

(51) Int. Cl. A01K 85/00

(52) U.S. Cl. 43/42.09; 43/42.28; 43/42.36

(57) ABSTRACT

The need for having multiple fishing lures, each with a separate visual characteristic such as pattern, color or colors, is reduced by providing a fishing lure with a selectively removable insert to permit another insert having a different visual characteristic to be substituted. An inner body is disposed within an outer body to form an insert chamber to receive a selectively removable insert. The color, colors or pattern of a fishing lure may be changed by substituting one insert with another. Additionally, the lure may also permit a skirts may be selectively removable to

[symbol]

### FIELD OF THE INVENTION

The present invention relates to fishing lures. More specifically, the invention relates to modular fishing lures that support user changeable colors.

### BACKGROUND OF THE INVENTION

Fishing lures are designed to elicit strikes from fish. The design of a fishing lure varies depending on the species of fish the lure is designed to attract, the water conditions, the time of year, the time of day and amount of sunlight. The design features of a fishing lure are intended to create action such as a bubble trail, popping, dashing, and other surface action. The designs that produce these actions, along with the size of the lure, are intended to attract a particular species of fish. For example, a lure intended to attract a big game fish such as a blue marlin would have a different design from a lure intended to attract a walleye.

Within a class of lures designed to attract a species of fish are a variety of colors and patterns. For example, dark colors are best at night, such as black, dark blue and purple, because they cast the best silhouette. In the winter, when there is a lot of silt or algae, green, blue and yellow are preferred. Red, orange, silver and metallic are best for bright summer days. Additionally, color combinations and patterns also play a role in attracting fish. A single lure may cost fifty dollars or more. As water and climate conditions change, so do the most effective colors and patterns. Therefore, an angler must go through a significant expense to be prepared to fish for even a single variety of fish.

One solution to the problem of expense is disclosed in U.S. Pat. No. 6,058,643. The '643 patent discloses a modular lure kit having a plurality of flexible outer bodies of various colors that are secured to the frame by inserting the eyes through the body. However, this application is limited to lures that have soft outer bodies.

Thus, it is desirable to provide a modular fishing lure that permits a user to change the colors or patterns of the lure. It is further desirable to provide a modular fishing lure kit that contains a variety of inserts and skirts to modify the appearance of a lure.

### SUMMARY OF THE INVENTION

A fishing lure comprises a substantially transparent outer body having an annular sleeve portion extending from a base portion. An inner body is disposed within the outer body to form at least one insert cavity. At least one insert having a visual characteristic is disposed within the insert cavity. The insert is selectively removable to permit the insert to be changed to another insert having a different visual characteristic, whereby the appearance of said fishing lure may be changed. The visual characteristic of the insert may be selected from the group consisting of one color, multiple colors, and a pattern.

The fishing lure may further comprise an annular projection extending from the outer body adjacent to the base portion to secure a skirt. The skirt is selectively removable to permit the skirt to be changed.

A fishing lure kit to form a selectively changeable fishing lure, comprises at least one substantially transparent outer body having an annular sleeve portion extending from a base portion and at least one inner body provided to be disposed within the outer body to form at least one insert cavity. A plurality of inserts are provided that have a variety of visual characteristics. The inserts are provided to be disposed within the insert cavity. The inserts are selectively removable to permit one of the plurality of inserts to be interchanged for another one of the inserts having a different visual characteristic, whereby the appearance of the fishing lure may be changed. The visual characteristic of the inserts is selected from the group consisting of one color, multiple colors, and a pattern.

The fishing lure kit may further comprise a plurality of skirts, each of said skirts have a different visual characteristic. An annular projection extends from the outer body adjacent to the base portion to secure one of the plurality of skirts, whereby one of the plurality of skirts may be interchanged for another one of the plurality of skirts having a different visual characteristic.

Further objects, features and advantages of the present invention will become apparent to those skilled in the art from analysis of the following written description, the accompanying drawings and the appended claims.

### BRIEF DESCRIPTION OF THE DRAWINGS

FIG. 1a is a plan view of one embodiment of the modular fishing lure of the present invention;

FIG. 1b is a side view of one embodiment of the modular fishing lure of the present invention;

FIG. 1c is a front view of one embodiment of the modular fishing lure of the present invention;

FIG. 2 is an exploded view of one embodiment of the modular fishing lure of the present invention;

FIG. 3 a is a partial exploded view of another embodiment of the modular fishing lure of the present invention; and

FIG. 4 is an illustration of an exemplary modular fishing lure kit according to the principals of the present invention.

### DESCRIPTION OF THE PREFERRED EMBODIMENT

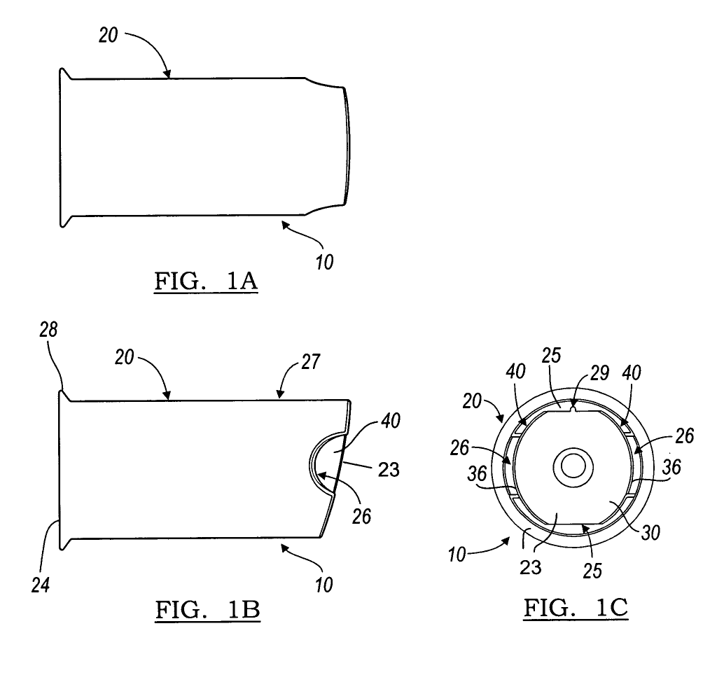

With initial reference to FIG. 1a, a plan view of one embodiment of the modular fishing lure 10 according to the principles of the present invention is shown. The fishing lure 10 comprises a substantially transparent outer body 20. Referring now also to FIG. 1b, a side view of one embodiment of the modular fishing lure 10 of the present invention is shown. The outer body 20 has an annular sleeve portion 22 extending from a base portion 24. At least one scallop 26 is formed within the sleeve portion 22 at a distal end 27 of outer body 20 from the base portion 24. In the preferred embodiment of outer body 20 and inner body 30 are made from an acrylic plastic, although any suitable material known in the art may be substituted for color plastic.

Referring now to FIG. 1c, a front view of one embodiment of the modular fishing lure 10 of the present invention is shown. Inner body 30 is disposed within the outer body 20 to form at least one insert cavity 36. In the present embodiment, a pair of insert cavities 36 are separated by a pair of positioning features 25. A key 29 prevents inner body 30 from being inserted into outer body 20 improperly. Although a pair of insert cavities 36 are shown in the present embodiment, as few as one insert cavity 36 is provided in accordance with the principals of the present invention. In the present embodiment, the positioning features 25 are complementary flat surfaces formed on the outer body 20 and inner body 30. It should be noted however that one or more positioning features 25 may be located elsewhere to permit a continuous annular insert cavity 36.

At least one insert 40, having a visual characteristic, is disposed within an insert cavity 36. In the present embodiment, a pair of inserts 40 are disposed into the pair of insert cavities 36. As each insert 40 is disposed into an insert cavity 36, each insert 40 is selectively removable to permit the insert 40 to be changed to another insert 40 having a different visual characteristic, whereby the appearance of the fishing lure 10 may be changed. According to the principals of the present invention, the visual characteristic of an insert 40 is selected from the group consisting of one color, multiple colors, and a pattern.

Although a pair of inserts 40 are shown as few as one insert may be employed. An insert 40 may take the form of a continuous annular sleeve in the event the insert cavity 36 is adapted to receive an insert 40 in the form of a continuous annular sleeve. As the insert 40 is selectively removable, the appearance of the fishing lure may be changed by substituting an insert 40 having different visual characteristic than the insert 40 presently disposed within insert cavity 36. Therefore, the color, colors or pattern of the lure 10 may be changed by substituting one insert 40 for another insert 40. The insert 40 may be formed from a foil, polymer or any suitable material known in the art.

In the present embodiment, a pair of scallops 26, each of which is adjacent to an insert cavity 36, are operatively disposed to provide access to the inserts 40. As such, the scallops 26 provide finger access to the inserts 40 for removable.

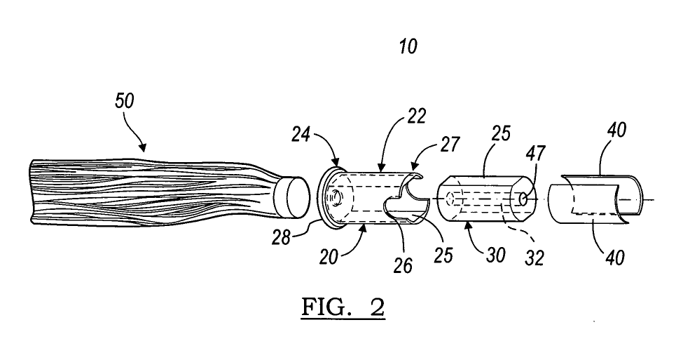

Referring now to FIG. 2, an exploded view of the modular fishing lure 10 of the present invention is shown. A skirt 50 having a visual characteristic, selected from the group consisting of one color, multiple colors, and a pattern, is functionally retained to outer body 20 by an annular projection 28. Annular projection 28 extends from outer body 20 adjacent to the base portion 24. The skirt 50 is selectively removable from the outer body 20. In the preferred embodiment, skirt 50 is formed of an elastomeric material, providing suitable compliance to permit skirt 50 to be retained and removed from outer body 20.

The lure 10 is assembled by disposing inner body 30 into outer body 20, thereby forming at least one insert cavity 36. At least one insert 40 is disposed within the insert cavity 36. The skirt 50 is attached to the outer body 20.

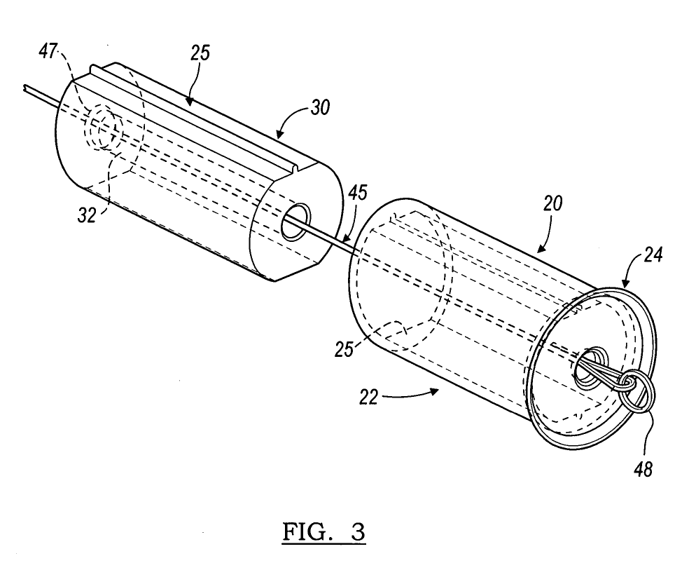

Referring now to FIG. 3, a partial exploded view of another embodiment of the modular fishing lure 10 of the present invention is shown. In the present embodiment, outer body 20 is formed without scallops disposed therein. Inner body 30 as the cavity 32 formed therethrough to permit a fishing line 45 to pass through the inner body and outer body. A ring 48 is securely attached to the fishing line 45. The ring 48 is provided to permit a hook (not shown) to be attached to the fishing line. An eyelet 47 is provided to reduce ware on the inner body 30 from contact with the fishing line 45.

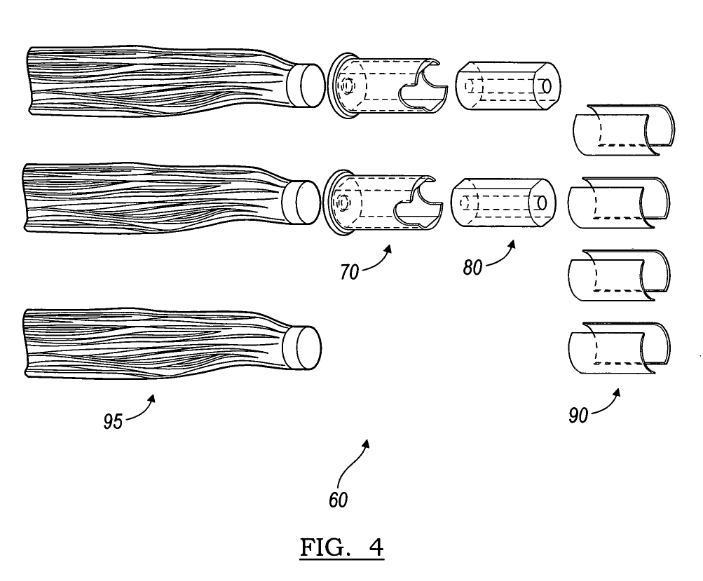

Referring now to FIG. 4, an illustration of an exemplary modular fishing lure kit 60 according to the principals of the present invention is shown. The kit 60 comprises at least one substantially transparent outer body 70 and at least one inner body 80 capable of being disposed within the outer body 70 to form at least one insert cavity (not shown). The kit 60 further comprises a plurality of inserts 90, having a variety of visual characteristics, capable of being disposed within the insert cavity. Each of the inserts 40 are selectively removable to permit one of the plurality of inserts 40 to be interchanged for another one of the plurality of inserts 40 and a different visual characteristic, whereby the appearance of a fishing lure may be changed.

The kit 60 further comprises a plurality of skirts 95, each skirt having a different visual characteristic. The plurality of skirts 95 may be interchanged for another one of the plurality of skirts 95 having a different visual characteristic.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

1. A fishing lure, comprising:
a substantially transparent outer body having an annular sleeve portion extending from a base portion;
an inner body, slidably disposed within said outer body cooperating to form a face on a distal surface of the lure, said inner body having exterior walls that substantially conform to inner walls of said outer body, to form at least one insert cavity having an opening in said face and extending longitudinally between said inner body and outer body for receiving at least one insert; and
at least one insert having a visual characteristic, said insert disposed within said insert cavity, said insert being selectively removable to permit said insert to be changed to another insert having a different visual characteristic, whereby the appearance of said fishing lure may be changed.

2. The fishing lure of claim 1, further comprising a longitudinally disposed positioning feature for rotationally aligning said outer body and said inner body.

3. The fishing lure of claim 1, wherein said inner body has a cavity therein to permit a fishing line to pass therethrough.

4. The fishing lure of claim 1, further comprising an annular projection extending from said outer body, said projection disposed adjacent to said base portion of said outer body to retain a skirt, whereby said skirt is selectively removable to permit the skirt to be changed.

5. The fishing lure of claim 1, further comprising a least one scallop formed within said sleeve portion of said outer body, said scallop disposed at a distal end of said outer body from said base portion to provide access to said insert cavity through an exterior wall of said outer body to permit selective replacement of said insert.

6. The fishing lure of claim 1, whereby the visual characteristic of said insert is selected from the group consisting of one color, multiple colors, and a pattern.

7. A fishing lure kit to form a selectively changeable fishing lure, comprising:
at least one substantially transparent outer body having an annular sleeve portion extending from a base portion;
at least one an inner body, slidably disposed within said outer body cooperating to form a face on a distal surface of the lure, said inner body having exterior walls that substantially conform to inner walls of said outer body, to form at least one insert cavity having an opening in said face and extending longitudinally between said inner body and outer body for receiving at least one insert; and
a plurality of inserts having a variety of visual characteristics, said inserts capable of being disposed within said insert cavity, said inserts being selectively removable to permit one of the plurality of said inserts to be interchanged for another one of the plurality of said inserts having a different visual characteristic, whereby the appearance of said fishing lure may be changed.

8. The fishing lure kit of claim 7, further comprising a longitudinally disposed positioning feature for rotationally aligning said outer body and said inner body.

9. The fishing lure kit of claim 7, wherein said inner body has a cavity therein to permit a fishing line to pass therethrough.

10. The fishing lure kit of claim 7, further comprising a plurality of skirts, each of said skirts having a different visual characteristic; and an annular projection extending from said outer body, said projection disposed adjacent to said base portion of said outer body to permit one of said plurality of skirts to be retained, whereby one of said plurality of said skirts may be interchanged for another one of the plurality of said skirts having a different visual characteristic.

11. The fishing lure kit of claim 7, further comprising a least one scallop formed within said sleeve portion of said outer body, said scallop disposed at a distal end of said outer body from said base portion to provide access to said insert cavity through an exterior wall of said outer body to permit selective replacement of said insert.

12. The fishing lure kit of claim 7, whereby the visual characteristic of the plurality of said inserts is selected from the group consisting of one color, multiple colors, and a pattern.
